(19) United States
(12) Patent Application Publication
(10) Pub. No.: US 2008/0111679 A1
(43) Pub. Date: May 15, 2008

(54) Secure corridor cassette tracking

(75) Inventors: Martin Ogg, Dundee (GB); David J. Sleeman, Dundee (GB)

Correspondence Address: YOUNG & THOMPSON, 209 Madison Street, Suite 500, ALEXANDRIA, VA, 22314, US

(73) Assignee: NCR Corporation

(21) Appl. No.: 11/598,994

(22) Filed: Nov. 14, 2006

(51) Int. Cl. H04Q 7/00

(52) U.S. Cl. 340/539.13

(57) ABSTRACT

A system and method for tracking the location of an item during transport of that item from a mobile location to a fixed location. Wireless links established between the mobile location, the fixed location, and the item to be transported, are utilized to calculate a location parameter of the item to be transported. The calculated location parameter of the item is compared to a secure corridor and security features of the item to be transported may be activated dependent upon the result of that calculation.

### TECHNICAL FIELD

The present application relates to a tracking system for valuables and particularly, but not exclusively, to a system for tracking containers of banknotes during delivery to Automated Teller Machines.

### BACKGROUND

Various organizations have a need to transport valuable items of one kind or another between physically separated locations in a secure manner. Possibly the most common example of this requirement is the transfer of banknotes from a central or local storage point to one or more Automated Teller Machines (ATMs). Due to the popularity of ATMs they require frequent replenishing with banknotes and therefore a relatively large amount of money is generally in transport between one or more financial institutions and ATMs. The secure transport of this money and the security of personnel employed in this task is naturally of great concern to banking organizations.

The bank notes dispensed by an ATM are held in individual cassettes, each cassette containing a banknote of one particular denomination. Cassettes are loaded with the banknotes at a central location and transported to the vicinity of an ATM by a secure vehicle. Upon arrival nearby to the ATM the cassettes of banknotes are carried by security personnel from the secure vehicle to the ATM where they are loaded into the ATM. During the transport from the secure vehicle to the ATM the cassettes are relatively exposed to theft and the security personnel are exposed to the risk of attack by persons wishing to steal the cassettes.

When cash cassettes are transferred between secure vehicles and ATMs they are typically housed within a container to provide additional security. Cash cassettes are placed into the container when transferred out of the secure vehicle, and removed from the container as they are loaded into an ATM. The transfer of cassettes from a secure vehicle to an ATM typically occurs between a vehicle at the road-side and a building. Accordingly, the transfer is commonly known as an “across the pavement” transfer and the containers used to house the cassettes during the transfer are known as Across The Pavement (ATP) devices.

ATP devices and/or cash cassettes typically include spoiling systems such that should a cassette or the ATP device be opened by an unauthorized person, the contents are spoiled, for example by the application of an indelible dye to the contents. Such spoiling systems are only effective if they are activated in the event of a theft. Spoiling systems may be activated either when a cassette or ATP device is opened in an incorrect manner (i.e. It is broken into by a thief), or when the ATP device is removed from the security personnel in possession of it. In the latter case, the system may be activated by the breaking of a physical link, or the detection of a lack of proximity between the cassette and the personnel, for example by a wireless system. Although these systems are effective, the former requires the system to be triggered by the thief opening the cassette or ATP device, and the latter presents the possibility of duress being applied to the security personnel to force them to accompany the cassette or ATP device thereby not activating the spoiling system. The thief may then attempt to open the cassette or ATP device without triggering the spoiling system. Other security systems may also be employed in cash cassettes or ATP devices, for example audible alarms or tracking systems.

The above description details the transport of cash cassettes to ATMs but the same principles and problems apply to the transport of any valuable media between secure locations.

The present invention seeks to provide a security system to efficiently activate security devices of transportable items, in particular security systems associated with the transport of cash cassettes to ATMs.

### SUMMARY

According to a first aspect of the present invention there is provided an item tracking system, comprising a first mobile wireless communications device and a fixed wireless communications device, a container for receiving an item to be transferred, the container having a second mobile wireless communications device, and a processing system connected to one of the wireless communications devices, wherein the first mobile wireless communications device and the fixed wireless communications device are configured to establish a wireless link there between, the first mobile wireless communications device and the fixed wireless communications device are each configured to also establish a wireless link with the second mobile wireless communications device, and the processing system is configured to calculate, using a parameter of each of the wireless links, a location parameter of the container relative to the first mobile wireless communications device and the fixed wireless communications device.

According to a second aspect of the present invention there is provided a method of tracking the location of a container having a first mobile wireless communications device during transport of that container from a mobile location having a second mobile wireless communications device, to a fixed location having a fixed wireless communications device, comprising the steps of: establishing a wireless link between the second mobile wireless communications device and the fixed wireless communications device, and between the first mobile wireless communications device and each of the second mobile wireless communications device and the fixed wireless communications device, measuring a parameter of each of the wireless links, and calculating, using a parameter of each of the wireless links, a location parameter of the first mobile wireless communications device, relative to the second mobile wireless communications device and the fixed wireless communications device.

The fixed wireless communications device may be mounted in a self-service terminal (SST). The first mobile wireless communications device may be mounted in a secure vehicle.

The container may be an across the pavement device for transporting cash cassettes between a secure vehicle and an SST.

The across the pavement device may have a security system. The security system may be a spoiling system.

The security system may be activated dependent upon the location parameter of the container calculated by the processing system.

The location parameter may be a measure of the deviation of the container from a straight line between the first mobile wireless communications device and the fixed wireless communications device.

The location parameter of the container may be compared to a secure corridor, the deviation of the edges of that secure corridor from a straight line between the first mobile wireless communications device and the fixed wireless communications device varying along that straight line.

The parameter of the wireless links utilized to calculate the location parameter may be the received signal power of each wireless link.

There may be a plurality of processing systems, each being connected to a respective one of the wireless communications devices.

The secure vehicle may have an external communications link for transmitting information with regard to the location parameter of the container to a remote location.

The method may also comprise the step of activating a security feature of the container, based on the location parameter, which security feature may be an audible alarm or a spoiling system.

The security feature may be activated by the transmission of a signal from the second mobile wireless communications device to the first mobile wireless communications device.

The mobile location may be a secure vehicle. The fixed location may be an SST.

The container may be an across-the-pavement device for the transport of bank notes.

The measured parameter may be the received power of the wireless links.

The location parameter may be a measure of the deviation of the first mobile wireless communications device from a straight line between the second mobile wireless communications device and the fixed wireless communications device.

The method may further comprise the step of comparing the location parameter to a secure corridor, the deviation of the edges of that secure corridor from a straight line between the first mobile wireless communications device and the fixed wireless communications device varying along that straight line. The methods described herein may be performed by software in machine readable form on a storage medium. The method steps may be carried out in any suitable order and/or in parallel as is apparent to the skilled person in the art.

This acknowledges that software can be a valuable, separately tradable commodity. It is intended to encompass software, which runs on or controls “dumb” or standard hardware, to carry out the desired functions. For similar reasons, it is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a plan view of an Automated Teller Machine (ATM), a secure vehicle and an across the pavement device in accordance with the present invention;

FIG. 2 shows a schematic diagram of an Automated Teller Machine (ATM), a secure vehicle and an across the pavement device for providing a location monitoring system;

FIG. 3 is a diagram of the geometric relation of the items of FIG. 1;

FIG. 4 shows a schematic diagram of an Automated Teller Machine (ATM) and a secure vehicle with no straight route there between; and

FIG. 5 shows a flow chart of a method of monitoring the position of an across the pavement device.

### DETAILED DESCRIPTION

Embodiments of the present invention are described below by way of example only. These examples represent the best ways of putting the invention into practice that are currently known to the Applicant although they are not the only ways in which this could be achieved.

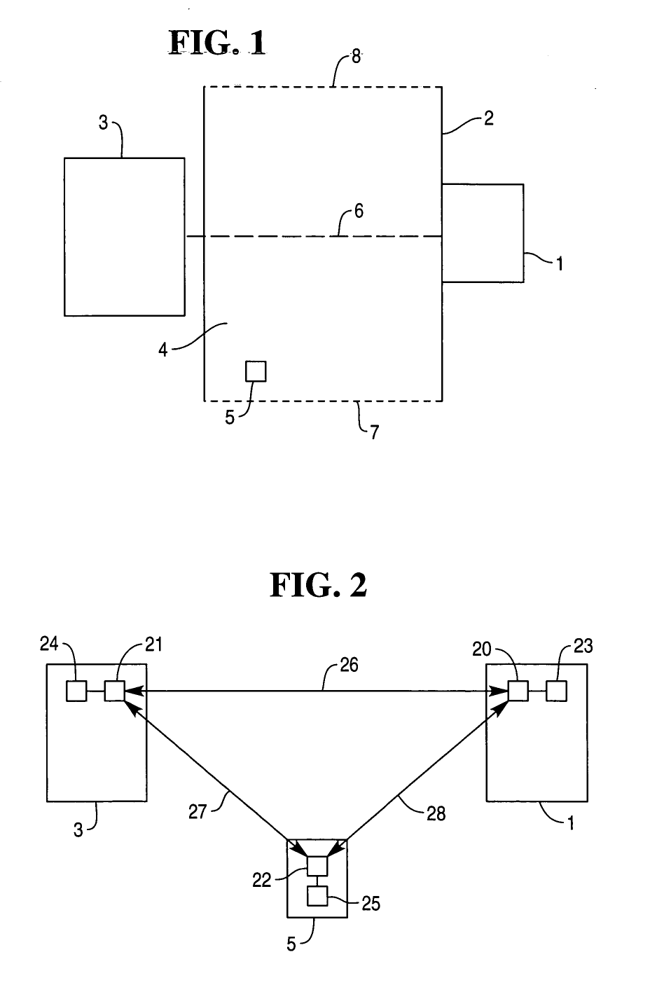

FIG. 1 shows a plan view of an Automated Teller Machine (ATM) 1 located at the front of a building 2, a secure vehicle 3 located at the curbside across the pavement 4 from the ATM 1, and an Across The Pavement (ATP) device 5. The ATP device 5 is utilized to transport cash cassettes between the secure vehicle 3 and the ATM 1 and is carried by security personnel (not shown). In order to minimize the time spent transferring the ATP device 5 between the secure vehicle 3 and the ATM 1, the security personnel should follow as direct a path as possible. Path 6 is a straight path, and hence the shortest path, between the secure vehicle 3 and the ATM 1. Although it cannot be expected that the security personnel will follow exactly that line, it is likely that the security personnel will only deviate from that path by a small amount. During a normal transfer of an ATP device 5 between the secure vehicle 3 and the ATM 1, the security personnel and ATP device 5 will therefore remain within a secure corridor, shown by 7 and 8 in FIG. 1. That secure corridor is defined as a distance from the direct path by which security personnel are likely to deviate. The amount of deviation that may be expected will depend upon the length of the route between the secure vehicle 3 and the ATM 1, and the nature of the pavement along that route, and will therefore vary for each ATM. Should the ATP device 5 move outside of the corridor, it is likely that the device has been stolen and so knowledge of the deviation of the ATP device 5 from the direct path 6 may be used to activate security features of the ATP device 5.

FIG. 2 shows a schematic diagram of an ATM 1 and a secure vehicle 3 having a system to allow the calculation of the location of the ATP device 5 relative to a direct path between a secure vehicle and an ATM. The ATM 1, secure vehicle 3 and ATP device 5, are equipped with wireless communications devices 20, 21, 22, and processing systems 23, 24, 25. Wireless communications devices 20, 21 are configured to establish a wireless link 26 between themselves and also to establish wireless links 27, 28 between themselves and the wireless communications device 22 of the ATP device 5. The wireless links 26, 27, 28 may be configured to transmit information between the devices, but transmission of information may not be required in the tracking system, as will be apparent to person skilled in the art. The wireless communications devices may be provided by short-distance radio systems as are well known in the art. A typical distance between a secure vehicle and an ATM during replenishment may be in the range of 50 to 100 metres.

The wireless communications devices 20, 21, 22 are configured to measure a parameter of wireless links established by them, such that the distance between the two devices forming the link can be established. For example, the power of radio signals decays with distance, and so by the measurement of the power of a received signal, and knowledge of the transmitted power, the distance between transmitter and receiver can be calculated. If an absolute, calibrated distance is not required, but only an indication of distance, as may be case in the system and method described herein, it may not be necessary to know the transmitted power, but only the relative received powers. Other parameters, for example time delay, may also be utilized to calculate the distance between the two ends of a link. The calculation of distance between the two ends of the links 26, 27, 28 may be performed by the wireless communications devices 20, 21, 22, or may be performed by the processing systems 23, 24, 25 in conjunction with the wireless communications devices 20, 21, 22. The calculation of distance between two ends of a wireless link is a well-known process and it will be clear to the skilled reader how such calculations may be performed and implemented.

The wireless link 26 represents the direct path between the secure vehicle 3 and the ATM 1, and so to determine whether the ATP device is within the secure corridor it is necessary to determine the deviation of the ATP device 5 from that direct path. As is explained in detail below, knowledge of the distances 26, 27, 28 enable calculation of that distance.

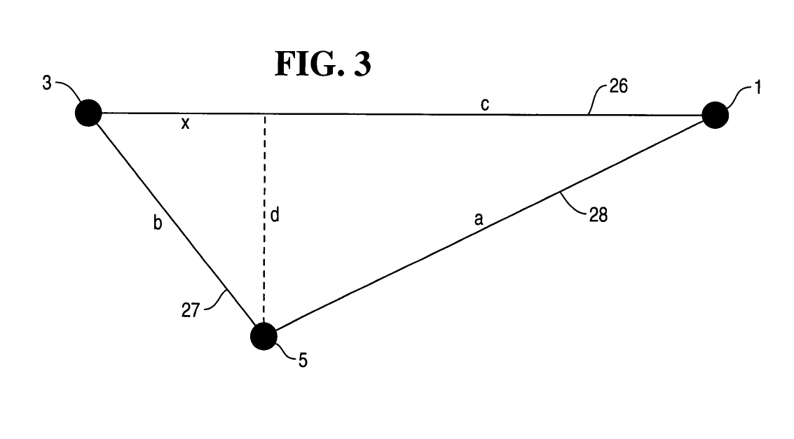

FIG. 3 shows a geometric plan view of the items of FIG. 2. The distance d represents the deviation of the ATP device 5 from the direct path, c. Distances a, b, c are known from measurements and calculations of the wireless links 26, 27, 28 that lie along those distances.

If the ATP device 5 was located on the direct line c between the secure vehicle 3 and the ATM 1, then the sum of the distances a and b would be equal (within the margin of measurement accuracy) to the distance c. If that sum is greater than the distance c then the ATP device 5 must be away from the direct line.

Using standard trigonometry, the deviation, d, of the ATP device from the direct path, c, can be calculated using the equation below.

$$d = b sin ( {cos}^{- 1} \frac{- {a}^{2} + {b}^{2} + {c}^{2}}{2 bc} )$$

It is therefore possible to calculate the distance of the ATP device from the direct path from knowledge of the distances a, b, c (which are calculated from parameters of the wireless links 26, 27, 28 as described above). The calculation of the distance d may be performed by one or more of the processing systems 23, 24, 25. Since each processing system only has access to parameters of two of the wireless links, it is necessary to transmit the relevant parameters of the remaining link to the processing system that is performing the calculation. As described above, the received power may be utilized, or alternatively a time delay. Alternatively, the processing systems and wireless communications devices may exchange information with regard to the wireless links on a continual, regular, or as required basis such that each processing system has the parameters required to calculate the deviation of the ATP device 5 from the direct path.

The progress of the ATP device 5 along the direct path c can also be calculated from the distances a, b, c thereby allowing the progress of the ATP device towards the destination to be monitored. The distance x along the direct path can be calculated using the equation below.

$$x = ( \frac{- {a}^{2} + {b}^{2} + {c}^{2}}{2 c} )$$

Access to ATMs for replenishment is typically via the rear of the machine and it is therefore probable that the ATP device 5 will move beyond the ATM 1 during replenishment. When that occurs, the calculation of d will not be possible when the ATP device 5, ATM 1 and secure vehicle 3 lie on a straight line, however the calculation of x will operate correctly. An inability to calculate d, and a value of x greater than c, therefore indicates that the ATP device is in this situation. If the secure vehicle 3, ATM 1 and ATP device 5 are not in a line, but the ATP device 5 is beyond the ATM 1, both calculations function correctly.

In the description below, references to the location of the ATP device are references to the distance d and/or distance x. The reference to location is not intended to imply that the absolute location of the ATP device is known, only that it is known in the context of distance d and/or x. If both x and d are known, there are two possible locations of the ATP device relative to the secure vehicle and ATM—located symmetrically about the direct path between the secure vehicle and the ATM. Since it is possible to calculate when the ATP device crosses the direct path (the sum of distances a and b will equal distance c), and it may be known which side of the direct path the ATP device has started, it may be possible to infer in which of the locations the ATP device is located.

A variety of actions may be performed on the basis of the location of the ATP device, calculated as described above, examples of which are described below. It will be apparent to the reader, however, that other actions may be performed based on the location, or that other uses may be made of the location information. Furthermore, use of the location is not restricted to the processing systems 23, 24, 25 and/or secure vehicle 3, ATM 1 or ATP device 5 but the location may also be transmitted to other systems, or stored for later analysis. Depending upon which processing system is performing the calculation of location, signals may be sent between the secure vehicle 3, ATM 1 and ATP device 5 to initiate a particular action, or one of those parts of the system may take action itself.

The location of the ATP device may be compared to a secure corridor appropriate for the current ATM. The secure corridor may be predetermined and selected on the basis of the particular ATM at which the secure vehicle is located, or may be calculated based on parameters such as the distance from the secure vehicle to the ATM. If it is detected that the ATP device is moving towards the edge of the secure corridor, action may be initiated. For example, an alarm on the ATP device may be activated to warn that the device is approaching the edge of the secure corridor. Such an alarm may be personal to the security personnel with the ATP device or may sound audibly to warn thieves that the unauthorized movement of the ATP device has been detected and that should the movement continue further action will be taken. Personnel in the secure vehicle may also be alerted to the movement.

If it is detected that the ATP device 5 has moved outside of the secure corridor, a variety of actions may be taken, dependent upon the preference of the operator, the precise situation, and which processing system is monitoring the distance. For example, if the processing system of the secure vehicle 3 is monitoring the location a signal may be sent from the secure vehicle to the ATP device 5 to activate the spoiling system of the ATP device 5, thereby rendering its contents useless. Alternatively, alarms may be sounded at the ATP device 5, in the secure vehicle 3, or an alert may be sent to a remote location to alert further personnel, or police authorities, that a theft may be occurring.

Since security personnel can be confident that security systems, for example a spoiling system, will be activated when an ATP device 5 is moved out of the secure corridor, there is no reason for them to resist duress being applied when a theft of an ATP device is attempted. Furthermore, since there is no benefit to a thief in taking the security personnel with the ATP device, nor anything for the thief to obtain from the security personnel to prevent activation of the security systems, there is a reduced likelihood of duress being applied to security personnel. The stress and danger of the job is therefore reduced, in addition to the reduced likelihood of a thief obtaining the cash without activation of a security system.

The foregoing description has related to the use of the tracking system in a situation where the secure vehicle can stop directly opposite the ATM to which a delivery is being made. The secure corridor is, in that case, located around a straight line across the pavement and the deviation of the edge of the secure corridor from the direct line is therefore constant with distance between the secure vehicle and the ATM. However, it is often the case that the route from the secure vehicle to the ATM is not a straight line.

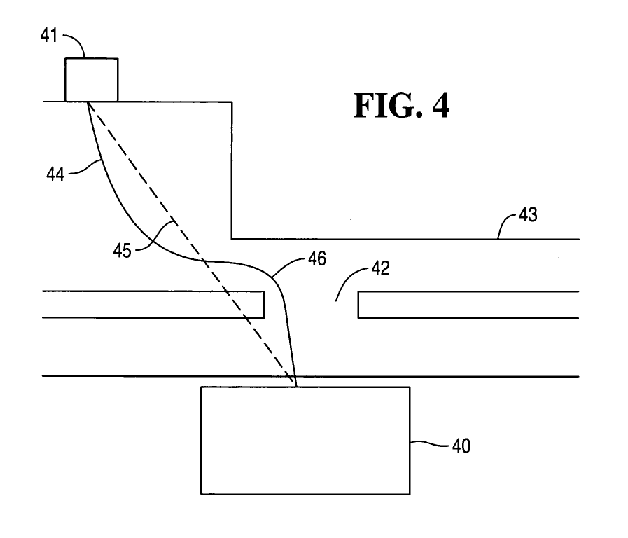

For example, FIG. 4 shows a secure vehicle 40 making a delivery to ATM 41 which is located through an entryway 42 and around a wall 43. The security personnel must therefore follow route 44 to reach the ATM 41. Since the location of the ATP device is calculated relative to a straight line 45 between the secure vehicle 40 and the ATM 41, even if the security personnel follows the correct route 44, the calculation of location will show a deviation.

If the secure corridor was defined as a fixed deviation from the direct path (as in the description above), the width of the corridor would have to be defined based on the maximum deviation of the correct route from the direct path, i.e. at point 46. That is undesirable since in that case, where the route coincides with the direct path (e.g. at the ATM end of the route in FIG. 4), the edge of the secure corridor would be a long way from the correct route. In that situation, it is preferable to define a secure corridor with a width which varies as a function of the position along the route, that is to say, the allowable deviation is a function of the distance x. Furthermore, rather than defining the secure corridor as a symmetrical area around the direct path, it is also possible to define the allowable deviation as being greater than a certain distance, but less than a larger distance. In that manner, the secure corridor can be defined symmetrically around a correct route does not lie along the direct path.

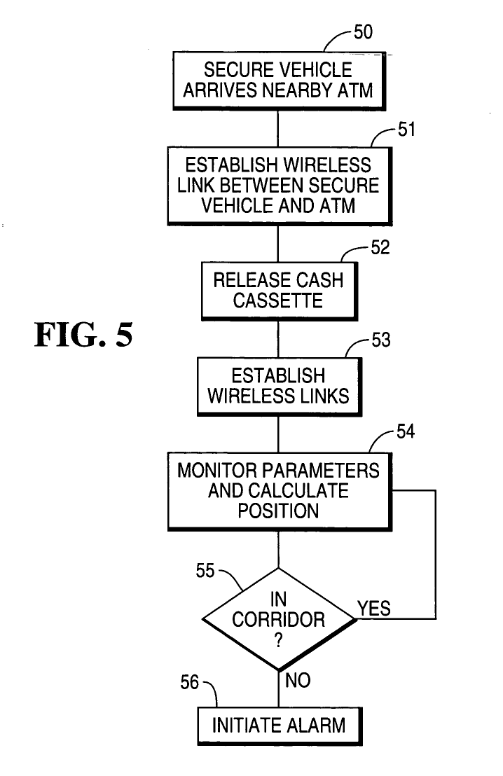

FIG. 5 shows a flow chart of a method of monitoring a cash cassette during replenishment of an ATM. A secure vehicle arrives 50 in the vicinity of the ATM to be replenished and a wireless link is established 51 between the ATM and the secure vehicle. A cash cassette is released 52 to the ATP device and wireless links are established 53 between the secure vehicle and the ATP device, and the ATM and the ATP device. The wireless links are monitored 54 and the position of the ATP device calculated as described previously. The calculated position is compared to the secure corridor for the current ATM and appropriate action taken 55 dependent upon the result of that comparison. If the ATP device is in the secure corridor the monitoring and calculation continues 54, but if the ATP device leaves the secure corridor appropriate action is initiated 56 by the security system. Many possible actions may be initiated upon movement of the ATP device out of the secure corridor, examples of which have been described previously.

The detection of the arrival of the ATP device at the ATM may be utilized to terminate the monitoring. Alternatively, monitoring may be terminated when the ATM indicates that the cash cassettes have been secured within the ATM.

The above method has been described with reference to the delivery of cash cassettes to an ATM, but as will be apparent to the person skilled in the art, the method is also applicable to the collection of cash cassettes from an ATM.

As will be apparent to the person skilled in the art, features of the apparatus and method are interchangeable. Accordingly features of the apparatus and system described previously may be utilized in the method, and features of the method may be incorporated into the features provided by the system and apparatus.

The information regarding the location of the ATP device may also be utilized to perform actions not related to the theft of the ATP device. For example, as the ATP device approaches the secure vehicle, the transfer device of the secure vehicle may be activated to be ready to accept the ATP device, or as the ATP device approaches the ATM, the ATM may be opened to accept a cash cassette from the ATP device.

The wireless links established for the purposes of monitoring the position of the ATP device may also be utilized to communicate information between the secure vehicle, ATP device and ATM. For example, information relating to the contents of the ATP device may be communicated between the secure vehicle and the ATM such that the ATM is aware of what is due to be loaded into it and can modify its records accordingly.

In the above description the word ‘between’ is not intended to limit the direction of a process, but rather to include both possible directions. For example ‘transfer between the secure vehicle and the ATM’ describes movement from the secure vehicle to the ATM, and movement from the ATM to the secure vehicle.

Any range or device value given herein may be extended or altered without losing the effect sought, as will be apparent to the skilled person.

It will be understood that the above description of a preferred embodiment is given by way of example only and that various modifications may be made by those skilled in the art.

The phrase “processing system” is used to refer to any electronic, or similar, system capable of processing data. For example, the processing system may be a computer system or a microprocessor, as is well known in the art.

In foregoing description and figures the wireless communications device and processing system have been described as separate units. As will be understood by the person skilled in the art, a single device may provide the functionality of both the wireless communications device and the processing system.

The above description has referred to the delivery of bank notes to ATMs, but as will be apparent to the person skilled in the art, the description is also relevant to the delivery of any valuable items to a particular location, including, but not limited to, other types of self-service terminals dispensing items other than money to customers.

What is claimed is:

1. An item tracking system, comprising:
a first mobile wireless communications device and a fixed wireless communications device,
a container for receiving an item to be transferred, the container having a second mobile wireless communications device, and
a processing system connected to one of the wireless communications devices, wherein
the first mobile wireless communications device and the fixed wireless communications device are configured to establish a wireless link there between,
the first mobile wireless communications device and the fixed wireless communications device are each configured to also establish a wireless link with the second mobile wireless communications device, and
the processing system is configured to calculate, using a parameter of each of the wireless links, a location parameter of the container relative to the first mobile wireless communications device and the fixed wireless communications device.

2. An item tracking system as claimed in claim 1 wherein the fixed wireless communications device is mounted in a self-service terminal (SST).

3. An item tracking system as claimed in claim 1 wherein the first mobile wireless communications device is mounted in a secure vehicle.

4. An item tracking system as claimed in claim 3 wherein the container is an across the pavement device for transporting cash cassettes between the secure vehicle and the SST.

5. An item tracking system as claimed in claim 1 wherein the across the pavement device has a security system.

6. An item tracking system as claimed in claim 5 wherein the security system is selected from one of a spoiling system and an audible alarm.

7. An item tracking system as claimed in claim 5 wherein the security system is activated dependent upon the location parameter of the container calculated by the processing system.

8. An item tracking system as claimed in claim 1 wherein the location parameter is a measure of the deviation of the container from a straight line between the first mobile wireless communications device and the fixed wireless communications device.

9. An item tracking system as claimed in claim 1, wherein the location parameter of the container is compared to a secure corridor, the deviation of the edges of that secure corridor from a straight line between the first mobile wireless communications device and the fixed wireless communications device varying along that straight line.

10. An item tracking system as claimed in claim 1 wherein the parameter of the wireless links utilized to calculate the location parameter is the received signal power of each wireless link.

11. An item tracking system as claimed in claim 1 wherein there are a plurality of processing systems, each being connected to a respective one of the wireless communications devices.

12. A method of tracking the location of a container having a first mobile wireless communications device during transport of that container from a mobile location having a second mobile wireless communications device, to a fixed location having a fixed wireless communications device, comprising the steps of:
establishing a wireless link between the second mobile wireless communications device and the fixed wireless communications device, and between the first mobile wireless communications device and each of the second mobile wireless communications device and the fixed wireless communications devices,
measuring a parameter of each of the wireless links, and
calculating, using a parameter of each of the wireless links, a location parameter of the container, relative to the second mobile wireless communications device and the fixed wireless communications device.

13. A method of tracking the location of a container as claimed in claim 12 further comprising the step of activating a security feature of the container, based on the location parameter.

14. A method of tracking the location of a container as claimed in claim 12 wherein the security feature is a selected one of an audible alarm and a spoiling system.

15. A method of tracking the location of a container as claimed in claim 13 wherein the security feature is activated by the transmission of a signal from the second mobile wireless communications device to the first mobile wireless communications device.

16. A method of tracking the location of a container as claimed in claim 12 wherein the mobile location is a secure vehicle and the fixed location is a self service terminal.

17. A method of tracking the location of a container as claimed in claim 12 wherein the container is an across the pavement device for the transport of banknotes.

18. A method of tracking the location of a container as claimed in claim 12 wherein the measured parameter is the received power of wireless link.

19. A method of tracking the location of a container as claimed in claim 12 wherein the location parameter is a measure of the deviation of the container from a straight line between the second mobile wireless communications device and the fixed wireless communications device.

20. A method of tracking the location of a container as claimed in claim 12, further comprising the step of comparing the location parameter to a secure corridor, the deviation of the edges of that secure corridor from a straight line between the first mobile wireless communications device and the fixed wireless communications device varying along that straight line.
